(19) United States
(12) Patent Application Publication
(10) Pub. No.: US 2026/0001430 A1
(43) Pub. Date: Jan. 1, 2026

(54) VEHICLE CHARGING SYSTEM FOR AN ELECTRIC VEHICLE HAVING ARC DETECTION

(71) Applicant: TE Connectivity Solutions GmbH, Schaffhausen (CH)

(72) Inventors: Nathan Philip Myer, Middletown, PA (US); David Bruce Sarraf, Middletown, PA (US); Robin Wesson, Middletown, PA (US); Paul Angell, Middletown, PA (US)

(21) Appl. No.: 18/976,572

(22) Filed: Dec. 11, 2024

Related U.S. Application Data
(60) Provisional application No. 63/665,354, filed on Jun. 28, 2024.

(51) Int. Cl. B60L 53/62; B60L 3/00; B60L 3/04; B60L 53/16; H02H 1/00

(52) U.S. Cl. CPC B60L 53/62; B60L 3/0046; B60L 3/04; B60L 53/16; H02H 1/0015

(57) ABSTRACT

A vehicle charging system for an electric vehicle includes a housing having a mating end for mating with a charging component and a charging terminal held by the housing connected to a power conductor to form a power transmission line. The vehicle charging system includes a charging controller for controlling vehicle charging along the power transmission line. The vehicle charging system includes a current sensor assembly coupled to the charging controller monitoring current transmitted along the power transmission line and generating a current output signal transmitted to the charging controller. The current sensor assembly is configured to detect an arc signature from an arc event and generate an arc output signal transmitted to the charging controller based on detection of the arc signature.

### CROSS REFERENCE TO RELATED APPLICATIONS

This application claims benefit to U.S. Application No. 63/665,354, filed 28 Jun. 2024, the subject matter of which is herein incorporated by reference in its entirety.

### BACKGROUND OF THE INVENTION

The subject matter herein relates generally to vehicle charging systems.

Electric vehicles (EV) and hybrid electric vehicles (HEV) include battery systems for operating the vehicles. The battery systems are charged by a vehicle charging system. For example, a charging connector, which is coupled to a power source, is connected to a charging inlet assembly of the vehicle to charge the battery. Known vehicle charging systems are not without disadvantages. For instance, the temperature of the terminals increase during charging, which may lead to damage to the charging components. In some instances, arcing may occur between the charging components, which can damage the charging connector and the charging inlet assembly.

A need remains for an arc detection method for a vehicle charging system of an electric vehicle.

### BRIEF DESCRIPTION OF THE INVENTION

In one embodiment, a vehicle charging system for an electric vehicle is provided and includes a housing having a mating end for mating with a charging component for the electric vehicle. The housing includes an internal cavity. The vehicle charging system includes a charging terminal held by the housing in the internal cavity. The charging terminal includes a mating end for mating with the charging component. The charging terminal is connected to a power conductor to form a power transmission line. The vehicle charging system includes a charging controller for controlling vehicle charging along the power transmission line. The vehicle charging system includes a current sensor assembly coupled to the charging controller. The current sensor assembly monitors current transmitted along the power transmission line and generates a current output signal. The current sensor assembly transmits the current output signal to the charging controller. The current sensor assembly is configured to detect an arc signature from an arc event and generate an arc output signal. The current sensor assembly is configured to transmit the arc output signal to the charging controller based on detection of the arc signature.

In another embodiment, a vehicle charging system for an electric vehicle is provided and includes a housing having a mating end for mating with a charging component for the electric vehicle. The housing includes an internal cavity. The vehicle charging system includes a charging terminal held by the housing in the internal cavity. The charging terminal includes a mating end for mating with the charging component. The charging terminal is connected to a power conductor to form a power transmission line. The vehicle charging system includes a charging controller for controlling vehicle charging along the power transmission line during a charging operation. The vehicle charging system includes a current sensor assembly coupled to the charging controller. The current sensor assembly includes a current sensor monitors a current signal transmitted along the power transmission line. The current sensor assembly includes a first sensor circuit coupled to the current sensor and having a low pass filter to measure the current signal in a low frequency range corresponding to the charging operation. The first sensor circuit is configured to generate a current output signal to the charging controller. The current sensor assembly includes a second sensor circuit coupled to the current sensor and having a high pass filter to measure the current signal in a high frequency range corresponding to an arc event. The second sensor circuit is configured to generate an arc output signal to the charging controller based on detection of the current signal in the high frequency range.

In a further embodiment, a charging inlet assembly for an electric vehicle is provided and includes a housing extending between a front and a rear. The housing has a chamber at the rear. The housing has a power connector at the front for receiving a charging connector. The power connector includes terminal channels between the front and the rear. The vehicle charging system includes charging terminals received in the corresponding terminal channels. Each of the charging terminals include a mating pin and a terminating end opposite the mating pin. The mating pin is positioned in the corresponding terminal channel for mating with the charging connector. The terminating end is positioned in the chamber at the rear of the housing and is connected to a power conductor to form a power transmission line. The vehicle charging system includes a charging controller for controlling vehicle charging along the power transmission line during a charging operation. The vehicle charging system includes a current sensor assembly coupled to the charging controller. The current sensor assembly monitors current transmitted along the power transmission line and generates a current output signal. The current sensor assembly transmits the current output signal to the charging controller. The current sensor assembly is configured to detect an arc signature from an arc event and generate an arc output signal. The current sensor assembly is configured to transmit the arc output signal to the charging controller based on detection of the arc signature.

### BRIEF DESCRIPTION OF THE DRAWINGS

FIG. 1 is a schematic view of a vehicle charging system in accordance with an exemplary embodiment.

FIG. 2 is a front perspective view of a charging component in accordance with an exemplary embodiment.

FIG. 3 is a rear perspective view of the charging component in accordance with an exemplary embodiment.

FIG. 4 is a perspective view of the charging controller in accordance with an exemplary embodiment.

FIG. 5 is a cross-sectional view of the charging component in accordance with an exemplary embodiment showing a second charging component coupled to the charging component.

FIG. 6 is a cross-sectional view of the charging component in accordance with an exemplary embodiment showing the second charging component coupled to the charging component.

### DETAILED DESCRIPTION OF THE INVENTION

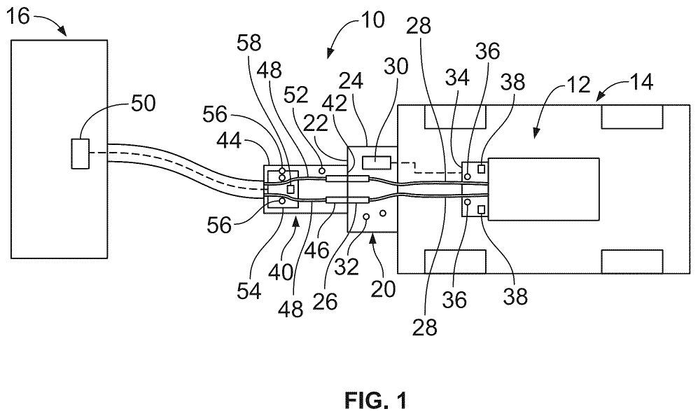

FIG. 1 is a schematic view of a vehicle charging system 10 in accordance with an exemplary embodiment. The vehicle charging system 10 is used for charging a battery system 12 of a vehicle 14, such as an electric vehicle or a hybrid electric vehicle. The vehicle charging system 10 includes a first charging component 20 and a second charging component 40. The first and second charging components 20, 40 are coupled together to charge the battery system 12 of the vehicle 14. In an exemplary embodiment, the first charging component 20 is coupled to the vehicle 14 and the second charging component 40 is coupled to a power supply 16 used for charging the battery system 12 of the vehicle 14. For example, the first charging component 20 may be a charging inlet assembly 22 mounted to the vehicle 14 and the second charging component 40 may be a charging connector 42 (for example, charging plug) which may be provided at a charging station or coupled to the building wiring of the home or building where the vehicle 14 is parked.

The first charging component 20 includes a housing 24 holding a plurality of charging terminals 26 and power conductors 28 coupled to the charging terminals 26. The charging terminals 26 may be DC charging terminals and/or AC charging terminals. The power conductors 28 may be power cables, busbars, or other types of conductors.

The first charging component 20 includes a charging controller 30, which may be used to control vehicle charging. For example, the charging controller 30 may control power supply along the charging terminals 26. The charging controller 30 may communicate with the second charging component 40, such as to control the second charging component 40. For example, the charging controller 30 may cause the second charging component 40 to turn on the power supply, turn off the power supply, increase power supply, and/or decrease power supply.

In an exemplary embodiment, the first charging component 20 includes a temperature sensor 32 operably coupled to the charging controller 30 to monitor a temperature of the charging terminals 26. The vehicle charging may be controlled based on the temperature readings of the temperature sensor 32. The temperature sensor 32 may be used for arc detection, such as by monitoring for a spike in temperature or a temperature above a threshold temperature, which may be higher than a normal operating temperature range.

In an exemplary embodiment, the first charging component 20 includes a current sensor assembly 34 operably coupled to the charging controller 30 to monitor current transmitted along the power transmission lines within the first charging component 20, such as at the charging terminal 26 and/or along the power conductors 28. The current sensor assembly 34 is operably coupled to the charging controller 30 to control the vehicle charging, such as based on the monitored current and/or based on detection of an arc event by the current sensor assembly 34. For example, when the arc event is detected, the charging controller 30 may immediately shut off the power supply to stop the charging process and extinguish the arc. The charging controller may communicate with the second charging component 40, such as to shut off the power supply to stop the charging process.

In an exemplary embodiment, the current sensor assembly 34 includes one or more current sensors 36 monitoring the current of the power transmission line(s) and one or more sensor circuits 38 processing signals from the current sensor(s) 36. In an exemplary embodiment, the current sensors 36 may be current transformers that measure the current of the power transmission line. The current transformer may include a primary coil that carries the current to be measured, and a secondary coil that produces a current proportional to the primary coil that is sent to a meter (for example, a voltmeter) or other instrument for measurement. However, other types of current sensors may be used in alternative embodiments. In an exemplary embodiment, the sensor circuits 38 include different sensor circuits 38 for detecting signals in different frequency ranges, such as a low frequency range and a high frequency range. The sensor circuits 38 may include low pass filters and high pass filters for controlling the frequency ranges. The sensor circuits 38 may include other types of filters for monitoring different frequencies of signals. The sensor circuits 38 may include processing devices, such as a digital signal processor, a neural network, frequency diplexers, and the like, to process the signals.

The current sensor assembly 34 (and/or components of the current sensor assembly 34) may be provided at various locations within the vehicle charging system 10. For example, the current sensor assembly 34 may be located in or on the first charging component 20. In other various embodiments, the current sensor assembly 34 may be located in or on the vehicle 14, such as in or on the battery system 12. For example, the current sensor assembly 34 may be incorporated in a battery distribution unit (BDU) or other component of the battery system 12.

The second charging component 40 includes a housing 44 holding a plurality of charging terminals 46 and power conductors 48 coupled to the charging terminals 26. The charging terminals 46 are configured to be mated with the charging terminals 26. In various embodiments, the charging terminals 46 are socket terminals and the charging terminals 26 are pin terminals; however, other types of terminals may be used in alternative embodiments. The charging terminals 46 may be DC charging terminals and or AC charging terminals. The power conductors 48 may be power cables, busbars, or other types of conductors.

The second charging component 40 includes a charging controller 50, which may be used to control vehicle charging. For example, the charging controller 50 may control power supply along the charging terminals 46. The charging controller 50 may communicate with the first charging component 20. The charging controller 50 may turn on the power supply, turn off the power supply, increase the power supply, and/or decrease the power supply. The charging controller 50 may control the voltage and/or current supplied by the second charging component 40.

In an exemplary embodiment, the second charging component 40 includes a temperature sensor 52 operably coupled to the charging controller 50 to monitor a temperature of the charging terminals 46. The vehicle charging may be controlled based on the temperature readings of the temperature sensor 52. The temperature sensor 52 may be used for arc detection, such as by monitoring for a spike in temperature or a temperature above a threshold temperature, which may be higher than a normal operating temperature range.

In an exemplary embodiment, the second charging component 40 includes a current sensor assembly 54 operably coupled to the charging controller 50 to monitor current transmitted along the power transmission lines within the second charging component 40, such as at the charging terminal 46 and/or along the power conductors 48. The current sensor assembly 54 is operably coupled to the charging controller 50 to control the vehicle charging, such as based on the monitored current and/or based on detection of an arc event by the current sensor assembly 54. For example, when the arc event is detected, the charging controller 50 may immediately shut off the power supply to stop the charging process and extinguish the arc. The charging controller 50 may communicate with the first charging component 20, such as the charging controller 30, to shut off the power supply to stop the charging process.

In an exemplary embodiment, the current sensor assembly 54 includes one or more current sensors 56 monitoring the current of the power transmission line(s) and one or more sensor circuits 58 processing signals from the current sensor(s) 56. In an exemplary embodiment, the current sensors 56 may be current transformers that measure the current of the power transmission line. The current transformer may include a primary coil that carries the current to be measured, and a secondary coil that produces a current proportional to the primary coil that is sent to a meter (for example, a voltmeter) or other instrument for measurement. However, other types of current sensors may be used in alternative embodiments. In an exemplary embodiment, the sensor circuits 58 include different sensor circuits 58 for detecting signals in different frequency ranges, such as a low frequency range and a high frequency range. The sensor circuits 58 may include low pass filters and high pass filters for controlling the frequency ranges. The sensor circuits 58 may include other types of filters for monitoring different frequencies of signals. The sensor circuits 58 may include processing devices, such as a digital signal processor, a neural network, frequency diplexers, and the like, to process the signals.

The current sensor assembly 54 (and/or components of the current sensor assembly 54) may be provided at various locations within the vehicle charging system 10. For example, the current sensor assembly 54 may be located in or on the second charging component 40. For example, the current sensor assembly 54 may be located in or on the charging plug. In other various embodiments, the current sensor assembly 54 may be located in or on the power supply 16, such as in or on the charging station.

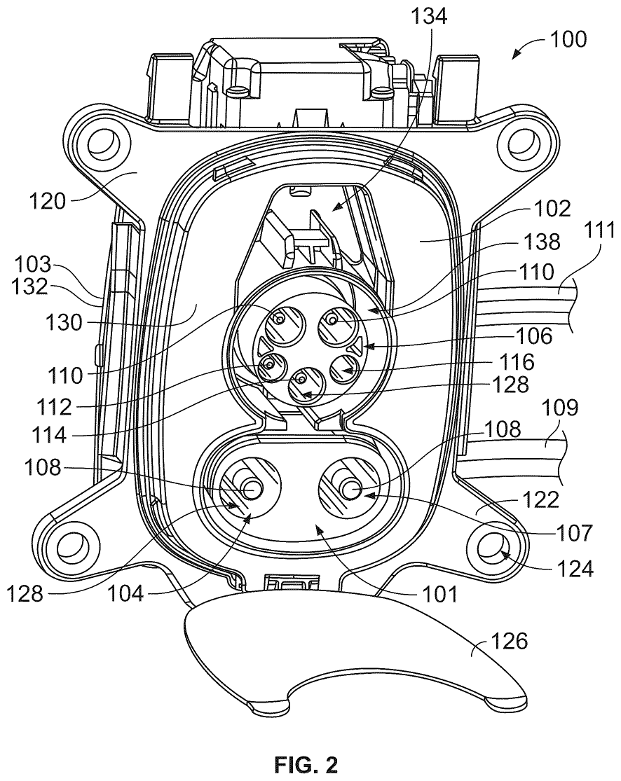

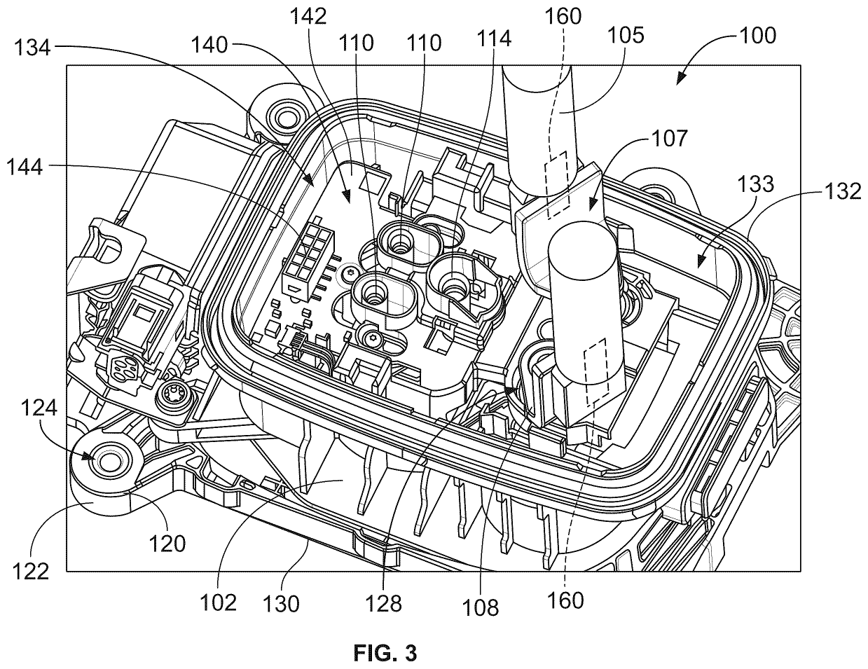

FIG. 2 is a front perspective view of a charging component 100 in accordance with an exemplary embodiment. FIG. 3 is a rear perspective view of the charging component 100 in accordance with an exemplary embodiment. In the illustrated embodiment, the charging component 100 is a charging inlet assembly and may be referred to hereinafter as a charging inlet assembly 100. The charging inlet assembly 100 is configured to be mated with a complimentary charging component (not shown), such as a charging connector or plug charger.

The charging inlet assembly 100 defines a power connector 101 configured to be electrically connected to the charging connector for charging a battery system of a vehicle, such as an electric vehicle (EV) or hybrid electric vehicle (HEV). In an exemplary embodiment, the charging inlet assembly 100 is configured for mating with a DC fast charging connector, such as the SAE combo CCS charging connector or the NACS charging connector, in addition to AC charging connectors, such as the SAE J1772 charging connector. In various embodiments, the charging inlet assembly 100 has a CCS1 (5 pin) AC configuration. In other various embodiments, the charging inlet assembly 100 may have a CCS2 (7 pin) AC configuration. Other standard inlet configurations may be used in alternative embodiments, such as the NACS configuration.

The charging inlet assembly 100 includes a housing 102 configured to be mounted in the vehicle. The housing 102 forms a portion of the power connector 101 for mating with the charging connector. A rear cover 103 (shown in FIG. 2 but removed in FIG. 3 to illustrate components of the charging inlet assembly 100) is coupled to a rear of the housing 102 to close out the housing 102 and the internal components of the charging inlet assembly 100. The rear cover 103 may be sealed to the housing 102 to prevent moisture and debris from entering the internal compartment of the housing 102. In an exemplary embodiment, the power connector 101 defines a DC charging portion 104 and an AC charging portion 106. The charging portions 104, 106 may form receptacles or openings that receive a plug of the charging connector. The charging inlet assembly 100 includes a plurality of charging terminals 107 for connection to the charging connector. Power conductors 105 are electrically connected to the charging terminals 107 and routed within the vehicle, such as to the battery. The power conductors 105 may be power cables, busbars, or other types of conductors. The charging terminals 107 and the power conductors 105 form power transmission lines through the vehicle.

The DC charging portion 104 is configured for mating with a DC charging connector or a DC section of the charging connector. The DC charging portion may be used for fast charging. In an exemplary embodiment, the charging terminals 107 of the charging inlet assembly 100 include DC charging terminals 108 at the DC charging portion 104, such as a pair of the DC charging terminals 108. The DC charging terminals 108 are configured to be electrically connected to the DC charging connector. The charging inlet assembly 100 includes DC power conductors 109 (FIG. 2) electrically connected to the DC charging terminals 108. The DC power conductors 109 may be terminated directly to the DC charging terminals 108, such as being crimped or welded to the DC charging terminals 108. In other embodiments, the DC power conductors 109 may be electrically connected to the DC charging terminals 108 through a separable interface, such as through connectors mated to the housing 102 at the rear. The DC charging terminals 108 and the DC power conductors 109 form power transmission lines through the vehicle.

The AC charging portion 106 is configured for mating with an AC charging connector or an AC section of the charging connector. In an exemplary embodiment, the charging terminals 107 of the charging inlet assembly 100 includes AC power terminals 110 at the AC charging portion 106, such as a pair of the AC power terminals 110. The charging terminals 107 of the charging inlet assembly 100 include a proximity terminal 112 at the AC charging portion 106. The charging terminals 107 of the charging inlet assembly 100 include a ground terminal 114 at the AC charging portion 106. The charging terminals 107 of the charging inlet assembly 100 include a communication terminal 116 at the AC charging portion 106. The AC power terminals 110, the proximity terminal 112, the ground terminal 114, and the communication terminal 116 are configured to be electrically connected to the AC charging connector.

The charging inlet assembly 100 includes AC conductors 111 (FIG. 2) electrically connected to the corresponding AC terminals 110, 112, 114, 116. The AC conductors 111 may be terminated directly to the AC terminals 110, 112, 114, 116, such as being crimped or welded thereto. In other embodiments, the AC conductors 111 may be electrically connected to the AC terminals 110, 112, 114, 116 through a separable interface, such as through connectors mated to the housing 102 at the rear. The AC charging terminals 110 and the AC power conductors 111 form power transmission lines through the vehicle.

The conductors 109, 111 extend from the charging inlet assembly 100 to another component of the vehicle, such as the battery system of the vehicle. The conductors 109, 111 transmit power, such as to the battery of the vehicle. The DC power conductors 109 may transmit high voltage for charging the battery and the AC conductors 111 may transmit low voltage for charging the battery. Optionally, one or more of the conductors 111 may be electrically connected to a battery control unit (not shown) of the battery system, such as to transmit data between the charging inlet assembly 100 and the battery system, such as data relating to the charging operation. For example, the conductor 111 may transmit data relating to charging start/stop, operating temperature of the power terminals 108 and/or 110, or other charging data. The conductor 111 may send a proximity signal to the battery system indicating when the charging device is mated to the power connector 101 of the charging inlet assembly 100.

The charging inlet assembly 100 includes a mounting flange 120 (FIG. 1) coupled to the housing 102. The mounting flange 120 is used to couple the charging inlet assembly 100 to the vehicle. The mounting flange 120 includes mounting tabs 122 having openings 124 that receive fasteners (not shown) used to secure the charging inlet assembly 100 to the vehicle. Other types of mounting features may be used to secure the charging inlet assembly 100 to the vehicle. The mounting flange 120 may include a seal to seal the charging inlet assembly 100 to the vehicle.

In an exemplary embodiment, the charging inlet assembly 100 includes a terminal cover 126 (FIG. 2) at a front 130 of the housing 102. The terminal cover 126 is hingedly coupled to the mounting flange 120 and/or the housing 102. The terminal cover 126 is used to cover portions of the housing 102, such as the power connector 101. The terminal cover 126 may be used to cover the DC charging terminals 108 and/or the AC power terminals 110, which are located in corresponding terminal channels 128 in the housing 102.

The rear cover 103 is provided at a rear 132 of the housing 102 to close access to a rear chamber 133 at the rear 132 of the housing 102. The rear cover 103 may be clipped or latched onto the main part of the housing 102, such as using clips or latches. Other types of securing features, such as fasteners may be used in alternative embodiments. A perimeter seal may be provided between the rear cover 103 and the housing 102.

In an exemplary embodiment, the housing 102 of the charging inlet assembly 100 includes an internal cavity 134 that receives the components of the charging inlet assembly 100. The rear chamber 133 is at the rear of the internal cavity 134. The internal cavity 134 includes the terminal channels 128 that receive the corresponding charging terminals 107. The terminal channels 128 may be separated from each other and other components by walls of the housing 102. The internal cavity 134 includes a front chamber 138 at the front that receives the charging connector.

In an exemplary embodiment, the charging inlet assembly 100 includes a charging controller 140 for controlling charging of the vehicle through the charging inlet assembly 100. The charging controller 140 may be received in the internal cavity 134, such as in the rear chamber 133. The charging controller 140 may be communicatively coupled to the other charging component, such as the charging connector or plug, to control the charging activity or to another charging controller (for example, within the battery distribution unit) within the vehicle for controlling the charging process. The charging controller 140 may be communicatively coupled to the charging connector through one or more of the terminals 107. The charging controller 140 may turn on the power supply, turn off the power supply, increase the power supply, and/or decrease the power supply. The charging controller 140 may be located remote from the housing 102, such as at the battery control module of the vehicle charging system.

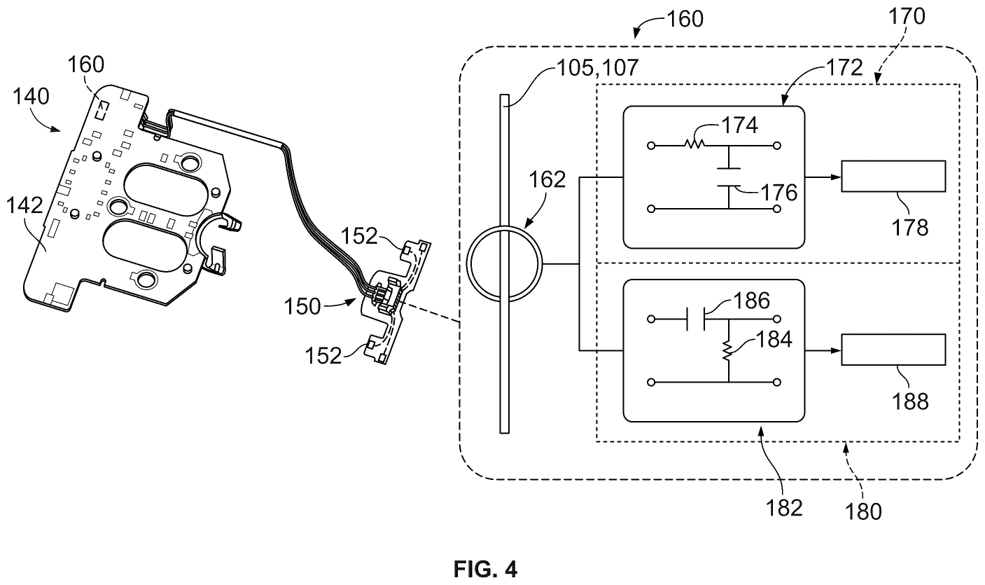

With additional reference to FIG. 4, which is a perspective view of the charging controller 140 in accordance with an exemplary embodiment, the charging controller 140 includes a circuit board 142, a control device 144, and other various components and circuitry to control operation of the charging inlet assembly 100. The control device 144 may be a processor or microcontroller. The control device 144 may include a multi-pin connector coupled to the circuit board 142.

In an exemplary embodiment, the control assembly includes one or more sensors 150 used to control the charging operation. The sensors 150 are used to sense operating characteristics of the components or the charging process to control charging. The sensors 150 are connected to the charging controller 140, such as being connected to the circuit board 142 by a wire or connector.

In various embodiments, the sensors 150 include temperature sensors 152. The temperature sensors 152 monitor operating temperatures of the DC charging terminals 108. The charging operation may be controlled based on the operating temperatures of the DC charging terminals 108. For example, as the temperature increases or approaches an allowable operating temperature, the power supply may be decreased. For example, the voltage or current may be reduced. The charging operation may stop if the operating temperature of the DC charging terminals 108 is above a threshold temperature. The temperature sensor 152 may be used for arc detection, such as by monitoring for a spike in temperature or a temperature above a threshold temperature, which may be higher than a normal operating temperature range.

In various embodiments, the sensors 150 include current sensors 160. The current sensors 160 monitor the current of the power transmission line(s) (for example, the charging terminals 107 and the power conductors 105). In an exemplary embodiment, the current sensor 160 includes a current transformer 162 that measures the current of the power transmission line. The current transformer 162 includes a primary coil 164 that carries the current to be measured, and a secondary coil 166 that produces a current proportional to the primary coil 164 that is sent to a meter 168 (for example, a voltmeter) or other instrument for measurement. However, other types of current sensors may be used in alternative embodiments, such as a Hall effect sensor. The Hall effect sensor may sense current at a frequency range similar to the frequency range on the power transmission line during an arc event (for example, having a sensing range similar to an arc signature).

In an exemplary embodiment, the current sensor 160 is coupled to one or more sensor circuits, such as a first sensor circuit 170 and a second sensor circuit 180. In an exemplary embodiment, the sensor circuits 170, 180 detect signals in different frequency ranges. For example, the first sensor circuit 170 is a low frequency sensor circuit configured to detect signals in a low frequency range. For example, the second sensor circuit 180 may detect signals indicative of normal charging operation (for example, Ac charging and/or DC charging). The first sensor circuit 170 may detect signals below 100 kHz. The first sensor circuit 170 may detect signals below 1 kHz, such as below 500 Hz. The first sensor circuit 170 may detect signals between 15-200 Hz. The second sensor circuit 180 is a high frequency sensor circuit configured to detect signals in a high frequency range. For example, the second sensor circuit 180 may detect signals indicative of an arc event. The second sensor circuit 180 may detect signals above 100 kHz. The first sensor circuit 170 may detect signals between 100-500 kHz, or above.

The first sensor circuit 170 may include a low pass filter 172 for controlling the frequency ranges. The low pass filter 172 may have a low frequency threshold to control the frequency range. For example, the low pass filter 172 passes low frequencies and attenuates high frequencies. The low pass filter 172 may be an RC low pass filter having a resistor 174 and a capacitor 176. The first sensor circuit 170 may include other electrical components in alternative embodiments. Other types of low pass filters may be used in alternative embodiments. The first sensor circuit 170 may include other types of filters in alternative embodiments. The first sensor circuit 170 generates a current output signal 178. The current output signal 178 may be a voltage output corresponding to the current relating to the charging level. The current output signal 178 may be a current output (for example, a current level output) corresponding to the sensed voltage relating to the charging level.

The second sensor circuit 180 may include a high pass filter 182 for controlling the frequency ranges. The high pass filter 182 may have a high frequency threshold to control the frequency range. For example, the high pass filter 182 passes high frequencies and attenuates low frequencies. The high pass filter 182 may be an RC high pass filter having a resistor 184 and a capacitor 186. The second sensor circuit 180 may include other electrical components in alternative embodiments. Other types of high pass filters may be used in alternative embodiments. The second sensor circuit 180 may include other types of filters in alternative embodiments. The second sensor circuit 180 generates an arc output signal 188. The arc output signal 188 may be a voltage output corresponding to the current relating to the arc event. The arc output signal 188 may be a current output (for example, a current level output) corresponding to the sensed voltage relating to the arc event.

The first sensor circuit 170 and the second sensor circuit 180 are coupled to the charging controller 140. For example, the first sensor circuit 170 transmits an output to the charging controller 140, such as the current output signal 178. The second sensor circuit 180 transmits an output to the charging controller 140, such as the arc output signal 188. The charging controller 140 may include processing devices, such as a microcontroller, a processor, a digital signal processor, a neural network, frequency diplexers, and the like, to process the signals. The charging controller 140 is used to control the charging operation. For example, the charging controller 140 may turn on the power supply, turn off the power supply, increase the power supply, and/or decrease the power supply based on the signals from the first and second sensor circuit 170, 180 (for example, based on the current output signal 178 and/or based on the arc output signal 188).

In an exemplary embodiment, the second sensor circuit 180 is used to detect an arc event within the charging inlet assembly 100, such as at mating ends of the DC charging terminals 108. For example, when the second sensor circuit 180 senses a high current, such as above the high frequency threshold, the second sensor circuit 180 outputs the arc output signal 188. In an exemplary embodiment, the second sensor circuit 180 detects an arc signature on the current sensor 160. The arc output signal 188 is transmitted to the charging controller 140 to control the charging operation based on the detection of the arc event. For example, when the arc event is detected, the charging operation is stopped. The current and voltage from the charging connector is stopped immediately to prevent damage to the components or the vehicle.

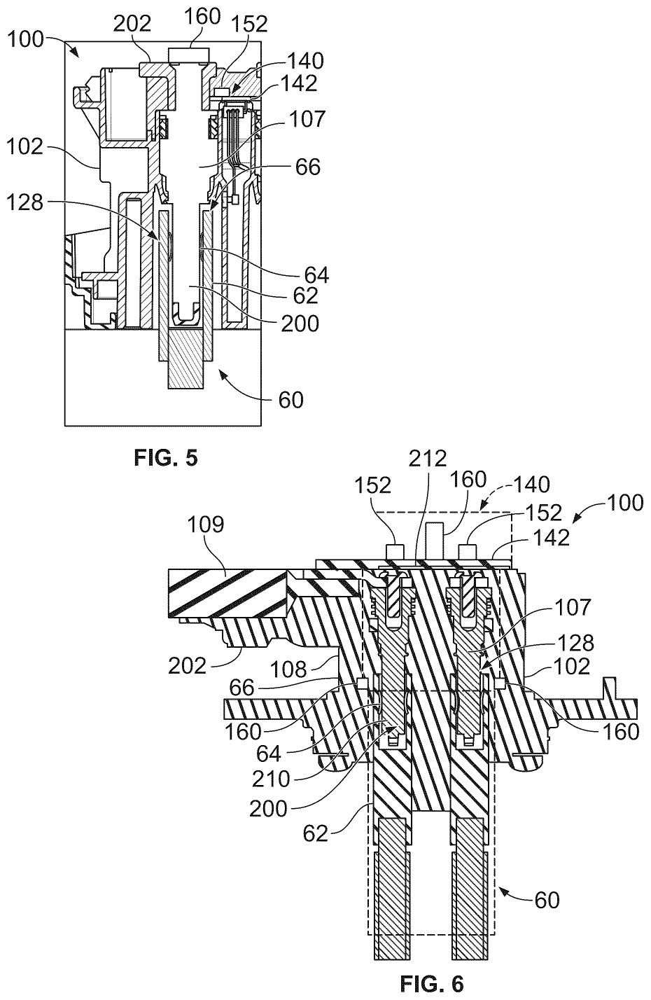

FIG. 5 is a cross-sectional view of the charging component 100 in accordance with an exemplary embodiment showing a second charging component 60 coupled to the charging component. FIG. 6 is a cross sectional view of the charging component 100 in accordance with an exemplary embodiment showing the second charging component 60 coupled to the charging component. In the illustrated embodiment, the charging component 100 is the charging inlet assembly. The second charging component 60 is a charging connector such as a plug charger.

The charging terminals 107 are shown in the terminal channels 128 of the housing 102. The charging terminals 107 are mated with charging terminals 62 of the charging connector 60. In the illustrated embodiment, the charging terminals 107 are pin terminals and the charging terminals 62 are socket terminals having spring contacts 64 in the sockets configured to electrically connect the charging terminals 62 and the charging terminals 107. The spring contacts 64 form a compliant, separable interface. The spring contacts 64 may be susceptible to failure due to overheating, and the failure may lead to an electrical arc event. The temperature sensors 152 monitor temperature of the charging terminals 107. The current sensors 160 monitor the current transmitted along the power transmission line (for example, along the charging terminal 107). In an exemplary embodiment, the current sensors 160 monitor the current on the power transmission line for arc events, such as at mating ends 66 of the charging terminals 62 or mating ends of the charging terminals 107.

The charging terminal 107 includes a mating pin 200 at a mating end 210 of the charging terminal 107 and a cable connector 202 at a rear 212 of the charging terminal 107. The charging terminal 107 extends along a longitudinal axis. The mating pin 200 is configured to be mated to the spring contact 64 of the charging terminal 62 of the charging connector 60. The cable connector 202 is configured to be electrically connected to the power conductor 109. In various embodiments, the cable connector 202 is configured to be terminated to the power conductor 109 by crimping to the power conductor 109. In other various embodiments, the cable connector 202 is terminated to the power conductor 109 by other processes, such as being welded to a weld tab at the rear end of the charging terminal 107. The conductor 109 may extend from the charging terminal 107 perpendicular to the longitudinal axis. Alternatively, the conductor 109 may extend from the charging terminal 107 parallel to the longitudinal axis.

In an exemplary embodiment, the temperature sensor 152 is coupled to the charging terminal 107 at the rear of the charging terminal 107, such as at the cable connector 202. The charging terminal 107 is both electrically conductive and thermally conductive. As the mating pin 200 heats up during charging, the entire body of the charging terminal 107 similarly heats up. Such increase in temperature is detected by the temperature sensor 152. In various embodiments, the temperature sensor 152 is a thermistor. The temperature sensor 152 may include a resistance temperature detector.

The current sensor 160 monitors the current along the power transmission line. Monitoring the current allows the current sensor 160 to detect the high frequency spikes in the current along the power transmission line during the arc event. The current sensor 160 thus detects the arc event within the charging inlet assembly 100. In various embodiments, the current sensor 160 monitors for an arc noise signature to detect the arc event. In an exemplary embodiment, the current sensor 160 monitors for an arc noise signature to detect the arc event. For example, arc noise is generated by the arc event, such as in the radiofrequency range as a consequence of arc energy. The characteristic noise signature of the electrical arcing may be in a predetermined range, such as between 1 kHz-100 GHz. The characteristic noise signature of the electrical arcing may be in a more particular range, such as between 100-500 kHz. The current sensor 160 detects the stochastic energy, or noise signature, generated by the electrical arc. In an exemplary embodiment, the current sensor 160 may monitor the power transmission line of the charging inlet assembly 100 to detect the arc noise signature on the power transmission line corresponding to the arc event. The current sensor 160 may monitor the current along the charging terminals 107 and/or the power conductors 109.

In various embodiments, the charging controller 140 may include an arc fault circuit interrupter (AFCI) device to protect against electrical arcing, such as to shut down the charging circuit when an arc is detected. The current sensor 160 monitors for the arc noise signature on the electrical circuit to detect the arc noise signature conducted on the power transmission line when the arc fault occurs. The charging controller 140 may include an internal processor in the ACFI device that distinguishes between normal operation and the hazardous arcing and will automatically open the circuit to reduce the risk of damage to the system.

In various embodiments, the current sensor 160 is connected to other wiring or circuits to detect the arc noise signature. The current sensor 160 may be located at the battery, such as at the battery distribution unit (BDU) rather than at the charging inlet housing. In other various embodiments, the current sensor 160 includes a separate, dedicated arc detection wire, which may be routed from the charging terminal 107 to the circuit board 142 or routed to another component, such as the battery control module. The current sensor 160 may include a resistor-capacitor-inductor network or filter at the charging terminal 107 or at the circuit board 142 to enhance sensitivity to arc signature and minimize sensitivity to normal vehicle electrical noise.

In an exemplary embodiment, the current sensor 160 noise is electrically coupled to the power transmission line at or near the cable connector 202 at the rear 212 of the charging terminal 107. The current sensor 160 may be coupled to the cable connector 202 or to the conductor 109. In various embodiments, the current sensor 160 may include a current transformer around the power conductor 109 to monitor the electrical signature along the conductor 109. In other various embodiments, the current sensor 160 may include a Hall sensor adjacent to the conductor 109 or the cable connector 202 to monitor the electrical signature along the electrical circuit. In various embodiments, the current sensor 160 includes an induction coil to monitor the electrical signature along the electrical circuit. The induction coil may be positioned at or near the cable connector 202 or the conductor 109. The induction coil may be provided on a circuit board, such as the circuit board 142 or another circuit board, such as a circuit board for the temperature sensor system. In various embodiments, the induction coil is broadly tuned with a capacitor. The current sensor 160 may include isolation from the power circuit, such as from the conductors of the conductor 109 or the cable connector 202 to prevent damage to the current sensor 160. For example, the current transformers, the hall sensor and/or the induction coil may have electrical isolation from the conductors carrying charging current. Electrical isolation may be provided by suitable DC blocking capacitors to isolate the components from the charging current conductors.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A vehicle charging system for an electric vehicle comprising:
a housing having a mating end for mating with a charging component for the electric vehicle, the housing including an internal cavity;
a charging terminal held by the housing in the internal cavity, the charging terminal including a mating end for mating with the charging component, the charging terminal being connected to a power conductor to form a power transmission line;
a charging controller for controlling vehicle charging along the power transmission line; and
a current sensor assembly coupled to the charging controller, the current sensor assembly monitoring current transmitted along the power transmission line and generating a current output signal, the current sensor assembly transmitting the current output signal to the charging controller, the current sensor assembly configured to detect an arc signature from an arc event and generate an arc output signal, the current sensor assembly configured to transmit the arc output signal to the charging controller based on detection of the arc signature.

2. The vehicle charging system of claim 1, wherein the current sensor assembly includes a current transformer measuring current in the power transmission line.

3. The vehicle charging system of claim 1, wherein the current sensor assembly includes a sensor monitoring the current at the power conductor.

4. The vehicle charging system of claim 1, wherein the current sensor assembly includes a sensor monitoring the current at the charging terminal.

5. The vehicle charging system of claim 1, wherein the current sensor assembly includes a high-pass filter having a high-frequency threshold, the current sensor assembly detecting the arc signature when the current sensor assembly detects a signal passing through the high-pass filter above the high frequency threshold.

6. The vehicle charging system of claim 1, wherein the current sensor assembly includes a low pass filter detecting signals below a low frequency threshold, the current output signal being based on the signals passing through the low pass filter below the low frequency threshold.

7. The vehicle charging system of claim 1, wherein the current sensor assembly includes a Hall effect sensor configured to detect the arc signature.

8. The vehicle charging system of claim 1, wherein the current sensor assembly includes an op-amp filter.

9. The vehicle charging system of claim 1, wherein the current sensor assembly includes a current sensor monitoring a current signal transmitted along the power transmission line, the current sensor assembly including a first sensor circuit coupled to the current sensor and having a low pass filter to measure the current signal in a low frequency range corresponding to the charging operation, the first sensor circuit configured to generate the current output signal to the charging controller, the current sensor assembly including a second sensor circuit coupled to the current sensor and having a high pass filter to measure the current signal in a high frequency range corresponding to an arc event, the second sensor circuit configured to generate the arc output signal to the charging controller based on detection of the current signal in the high frequency range.

10. The vehicle charging system of claim 9, wherein the charging controller interprets the current output signal and the arc output signal independently to control the vehicle charging.

11. The vehicle charging system of claim 9, wherein the charging controller interprets the current output signal in the arc output signal ratio metrically based on relative proportions of the current output signal in the arc output signal.

12. The vehicle charging system of claim 9, wherein the charging controller includes a digital signal processor processing the current output signal in the arc output signal to control the vehicle charging.

13. The vehicle charging system of claim 9, wherein the charging controller includes a neural network trained on sample arguments and false positive conditions.

14. The vehicle charging system of claim 9, wherein the current sensor includes in the field antenna, the current sensor assembly further comprising a second current sensor having a B field antenna monitoring the current signal transmitted along the power transmission line, the current sensor assembly including a third sensor circuit coupled to the second current sensor having a second low pass filter to measure the current signal from the B field antenna in a low frequency range corresponding to the charging operation, the third sensor circuit configured to generate a second current output signal to the charging controller, the current sensor assembly including a fourth sensor circuit coupled to the second current sensor having a second high-pass filter to measure the current signal form the B field antenna in a high-frequency range corresponding to an arc event, the fourth sensor circuit configured to generate a second arc output signal to the charging controller based on detection of the second current signal in the high-frequency range.

15. The vehicle charging system of claim 1, wherein the current sensor assembly detects current in a first frequency range in a first mode and detects current in a second frequency range in a second mode.

16. The vehicle charging system of claim 1, wherein the current sensor assembly is located in the internal cavity of the housing.

17. The vehicle charging system of claim 1, wherein the current sensor assembly is located in a battery distribution unit of a battery system of the electric vehicle.

18. The vehicle charging system of claim 1, wherein the charging controller shuts power supplied to the charging terminal when the arc event is detected.

19. The vehicle charging system of claim 1, wherein the housing is a charging connector housing configured to be removably coupled to a charging inlet housing of the charging component of the vehicle, the charging terminal being a socket terminal configured to be mated with a pin terminal of the charging component to power the vehicle through the pin terminal.

20. The vehicle charging system of claim 1, wherein the housing is a charging inlet housing configured to be mounted to the vehicle and configured to receive a charging connector housing of the charging component, the charging terminal including a pin configured to be mated with a socket terminal of the charging component to receive power from the charging component.

21. A vehicle charging system for an electric vehicle comprising:
a housing having a mating end for mating with a charging component for the electric vehicle, the housing including an internal cavity;
a charging terminal held by the housing in the internal cavity, the charging terminal including a mating end for mating with the charging component, the charging terminal being connected to a power conductor to form a power transmission line;
a charging controller for controlling vehicle charging along the power transmission line during a charging operation; and
a current sensor assembly coupled to the charging controller, the current sensor assembly including a current sensor monitoring a current signal transmitted along the power transmission line, the current sensor assembly including a first sensor circuit coupled to the current sensor and having a low pass filter to measure the current signal in a low frequency range corresponding to the charging operation, the first sensor circuit configured to generate a current output signal to the charging controller, the current sensor assembly including a second sensor circuit coupled to the current sensor and having a high pass filter to measure the current signal in a high frequency range corresponding to an arc event, the second sensor circuit configured to generate an arc output signal to the charging controller based on detection of the current signal in the high frequency range.

22. A charging inlet assembly for an electric vehicle comprising:
a housing extending between a front and a rear, the housing having a chamber at the rear, the housing having a power connector at the front for receiving a charging connector, the power connector including terminal channels between the front and the rear;
charging terminals received in the corresponding terminal channels, each of the charging terminals including a mating pin and a terminating end opposite the mating pin, the mating pin positioned in the corresponding terminal channel for mating with the charging connector, the terminating end positioned in the chamber at the rear of the housing and being connected to a power conductor to form a power transmission line;
a charging controller for controlling vehicle charging along the power transmission line during a charging operation; and
a current sensor assembly coupled to the charging controller, the current sensor assembly monitoring current transmitted along the power transmission line and generating a current output signal, the current sensor assembly transmitting the current output signal to the charging controller, the current sensor assembly configured to detect an arc signature from an arc event and generate an arc output signal, the current sensor assembly configured to transmit the arc output signal to the charging controller based on detection of the arc signature.
